(19) United States
(12) Patent Application Publication
(10) Pub. No.: US 2014/0089074 A1
(43) Pub. Date: Mar. 27, 2014

(54) METHODS AND SYSTEMS FOR ASSIGNING RECYCLING CREDITS

(71) Applicant: Empire Technology Development LLC, Wilmington, DE (US)

(72) Inventors: Timothy Londergan, Seattle, WA (US); Feng Wan, Issaquah, WA (US); Scott Needham, Mangerton (AU); James Wang, Beijing (CN)

(21) Appl. No.: 13/825,032

(22) PCT Filed: Sep. 21, 2012
(86) PCT No.: PCT/US2012/056489

§ 371 Date: Mar. 19, 2013

(51) Int. Cl. G06Q 10/00; G06Q 30/02

(52) U.S. Cl. CPC G06Q 10/20; G06Q 30/0226
USPC 705/14.27

(57) ABSTRACT

Methods and systems for determining a recycling credit are disclosed. A total recycling credit for a recycled material may be provided. A manufacturer percentage of the recycled material for a manufacturer may also be provided. The manufacturer percentage may be a percentage of the recycled material associated with the manufacturer. A processing device may determine a raw recycling credit to the manufacturer by multiplying the total recycling credit and the manufacturer percentage. The processing device may further determine a recycling credit to provide to the manufacturer by adjusting the raw recycling credit with a manufacturer green credit determined based on a manufacturer's environmental behavior.

### BACKGROUND

Recycling is a process for processing used materials or waste into new products in order to prevent the waste of potentially useful materials, to reduce energy usage from the production of new materials, to reduce air pollution caused by the incineration of waste materials, and to reduce water pollution as a result of landfilling. Recycling can reduce the need for conventional waste disposal and lower greenhouse gas emissions as compared with virgin production of new materials.

Recycling efforts have gradually gained traction at city, state and federal levels. For example, the state of Washington uses recycling credits to encourage residents to increase recycling and to reduce waste production. A recycling bin for each residence is weighed prior to recycled material entering into the recycling process. The weight of the recycled material is used to determine the recycling credit (in this case, a dollar amount), which is refunded to the residence owner.

One problem with this process is that no similar system exists for deciding a recycling credit to provide to material producers. When materials enter commerce, no conventional process exists for determining how much of a recycled material from a producer ends up in a land fill and how much is recycled for reuse. Such a system would be beneficial in encouraging a producer's recycling behavior and efforts towards having their products recycled by consumers.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a method of determining a recycling credit may include providing a total recycling credit for a recycled material, providing a manufacturer percentage of the recycled material for a manufacturer, wherein the manufacturer percentage comprises a percentage of the recycled material associated with the manufacturer, determining, by a processing device, a raw recycling credit to the manufacturer by multiplying the total recycling credit and the manufacturer percentage, and determining, by the processing device, a recycling credit to the manufacturer by adjusting the raw recycling credit with a manufacturer green credit determined based on a manufacturer's environmental behavior.

In an embodiment, a method of determining a recycling credit may include providing a total recycling credit for a recycled material, wherein at least a portion of the recycled material comprises a tag associated with a manufacturer, determining a manufacturer percentage corresponding to a percentage of the recycled material associated with the manufacturer based on the portion of the recycled material containing the tag, determining, by a processing device, a raw recycling credit to the manufacturer by multiplying the total recycling credit and the manufacturer percentage, and determining, by the processing device, a recycling credit to the manufacturer by adjusting the raw recycling credit with a manufacturer green credit determined based on a manufacturer's environmental behavior.

In an embodiment, a system for determining a recycling credit may include a processing device and a non-transitory computer-readable storage medium in operable communication with the processing device. The computer-readable storage medium contains one or more programming instructions that, when executed, cause the processing device to determine a total recycling credit for a recycled material, determine a manufacturer percentage of the recycled material for a manufacturer, wherein the manufacturer percentage comprises a percentage of the recycled material associated with the manufacturer, determine a raw recycling credit to the manufacturer by multiplying the total recycling credit and the manufacturer percentage, and determine a recycling credit to the manufacturer by adjusting the raw recycling credit with a manufacturer green credit determined based on a manufacturer's environmental behavior.

In an embodiment, a system for determining a recycling credit may include a processing device, an identification device in operable communication with the processor, and a non-transitory computer-readable storage medium in operable communication with the processing device. The computer-readable storage medium contains one or more programming instructions that, when executed, cause the processing device to determine a total recycling credit for a recycled material, wherein at least a portion of the recycled material comprises a tag associated with a manufacturer, receive tag identification information pertaining to the tag on the at least a portion of the recycled material from the identification device, determine a manufacturer percentage corresponding to a percentage of the recycled material associated with the manufacturer based on the recycled material and the at least a portion of the recycled material comprising the tag, determine a raw recycling credit to the manufacturer by multiplying the total recycling credit and the manufacturer percentage, and determine a recycling credit to the manufacturer by adjusting the raw recycling credit with a manufacturer green credit determined based on a manufacturer's environmental behavior.

### BRIEF DESCRIPTION OF THE FIGURES

FIG. 1 depicts a flow diagram for an illustrative method of determining a recycling credit according to an embodiment.

FIG. 2 depicts a flow diagram for an alternate illustrative method of determining a recycling credit according to an embodiment.

FIG. 3 depicts a block diagram for an illustrative system for determining a recycling credit according to an embodiment.

FIG. 4 depicts a block diagram of illustrative internal hardware that may be used to contain or implement program instructions according to an embodiment.

### DETAILED DESCRIPTION

The following terms shall have, for the purposes of this application, the respective meanings set for the below.

“Average generation” refers to an average number of times that a material is recycled. For example, if a material produced by a manufacturer is never recycled, the average generation for the material is 1, which means that the material is a virgin material or contains no recycled material. A second generation material means that the material is recycled once on average.

“Environmental behavior” refers to an action or inaction that results in an impact on the environment. Environmental behavior may result in deleterious effects such as pollution, increased energy consumption or waste products, and/or the like. Conversely, the use of green energy sources may be a positive environmental behavior. Additional or alternate environmental behaviors are also possible within the scope of this disclosure and will be apparent to a person of ordinary skill in the art based on the teachings herein.

“Environmental soundness” of a product design refers to the impact that a particular product design has upon the environment. For example, a product that is energy efficient, requires minimal CO₂ emissions, is recyclable, conserves resources, causes minimal environmental impact during use, has a simplified disassembly process, has long term usability, and reduces the use of environmentally harmful substances may have a product design that has a high environmental soundness.

A “manufacturer percentage” refers to a portion of a material assigned to a particular manufacturer. The manufacturer percentage for a recycled material may correspond to an amount of the recycled material that is produced by the manufacturer divided by the total amount of the recycled material produced by all manufacturers. Alternately, the manufacturer percentage may correspond to an amount of the recycled material produced by a manufacturer that is recycled divided by the total amount of the recycled material that is recycled. Alternate methods of determining a manufacturer percentage are also envisioned within the scope of this disclosure.

A “recycling credit” refers to a credit provided to an entity for recycling a material. A recycling credit may correspond to a cash refund or reward, a tax credit, or any other incentive provided to an individual or manufacturer, distributor or other corporate entity for recycling a material.

This disclosure identifies methods and systems for determining a recycling credit for a recycled material. In particular, this disclosure identifies methods and systems for determining a recycling credit for a recycled material produced by a materials producer or manufacturer.

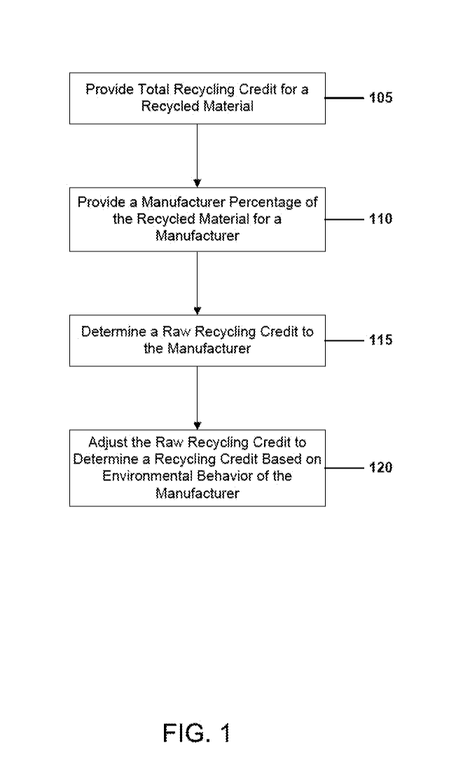

FIG. 1 depicts a flow diagram for an illustrative method of determining a recycling credit according to an embodiment. As shown in FIG. 1, a total recycling credit for a recycled material may be provided 105. The total recycling credit that is provided 105 may be equal to a sum of recycling credits assigned to one or more manufacturers for a recycled material. The total recycling credit that is provided 105 may be equal to the product of a unit credit for recycling a unit amount of a recycled material and the amount of the recycled material that is recycled.

In an embodiment, the recycled material may include a thermoplastic polymer, a thermosetting polymer or a combination thereof. In an embodiment, the recycled material may include polyethylene, polypropylene, polystyrene, polyvinyl chloride, polyacrylates, polyethylene terephthalate, polyacrylonitrile, polytetrafluoroethylene, polyester, polycarbonate, polyimide, polyamide, polyurethane or a combination thereof. In an embodiment, the recycled material includes epoxy resin, allyl resin, silicone, polyimide, polyurethane or a combination thereof. In an embodiment, the recycled material comprises a biodegradable polymer, such as polyhydroxyalkanoates, polylactic acid, polybutylene succinate, poycaprolactone, polyanhydride, polyvinyl alcohol, polysaccharide, cellulose, cellulose esters, lignin, lignocellulose or a combination thereof. In an alternate embodiment, the recycled material comprises metal, glass, ceramics or a combination thereof.

A manufacturer percentage of the recycled material is provided 110 for a manufacturer. The manufacturer percentage comprises a percentage of the recycled material associated with the manufacturer. For example, the manufacturer percentage may correspond to an amount of the recycled material that is produced by the manufacturer divided by the total amount of the recycled material produced by all manufacturers. In another embodiment, the manufacturer percentage may correspond to an amount of the recycled material produced by a manufacturer that is recycled divided by the total amount of the recycled material that is recycled. Alternate methods of determining a manufacturer percentage are also envisioned within the scope of this disclosure and will be apparent to those of ordinary skill in the art. In an embodiment, the manufacturer percentage comprises a percentage of the recycled material that is produced by the manufacturer by weight.

In an embodiment, providing 110 a manufacturer percentage of the recycled material may include determining a chemical composition of the recycled material. The chemical composition may include a plurality of chemical compounds and corresponding percentages of the recycled material attributable to each chemical compound. Providing 110 a manufacturer percentage of the recycled material may further include determining the manufacturer percentage of the recycled material produced by a manufacturer based on the chemical composition of the recycled material.

In an alternate embodiment, providing 110 a manufacturer percentage may include determining the manufacturer percentage based on a market share of the manufacturer with respect to the recycled material. In an embodiment, the market share may be based on the amount of product sold within a territory that encompasses a recycling facility. In an embodiment, the market share may be determined based on visual inspection of some or all of the recycled material in order to determine a manufacturer of the recycled material.

A processing device may determine 115 a raw recycling credit to provide to the manufacturer by, for example, multiplying the total recycling credit and the manufacturer percentage. The product of the total recycling credit and the manufacturer percentage may be equal to or approximately equal to the amount of the recycled material that is produced by the manufacturer.

The processing device may determine 120 a recycling credit to provide to the manufacturer by adjusting the raw recycling credit. For example, the raw recycling credit may be adjusted with a manufacturer green credit. The manufacturer green credit may be determined based on the manufacturer's environmental behavior.

The manufacturer green credit may be used to adjust the recycling credit provided to the manufacturer positively or negatively depending upon the manufacturer's environmental behavior.

For example, the raw recycling credit may be adjusted 120 by determining an average amount of energy consumed during the production of the recycled material. If the average amount of energy consumed during production is above a threshold, the raw recycling credit may be reduced by a fixed amount or an amount proportional to the difference between the threshold and the average amount of energy consumed. Conversely, if the average amount of energy consumed during production is less than a threshold, the raw recycling credit may be increased by a fixed amount or an amount proportional to the difference between the threshold and the average amount of energy consumed.

In an embodiment, the raw recycling credit may be adjusted 120 by determining a measure of environmental soundness of a product design of the recycled material. For example, the environmental soundness of the product design of the recycled material may consider energy efficiency, CO₂ emissions, resource conservation, recyclability, environmental impact during use of the product incorporating the recycled material, a disassembly process, long term usability of the product, and/or a reduction in the use of environmentally harmful substances resulting from the product design or the use of the product. Recycled material stemming from a product having a product design with high environmental soundness may receive an increase to the raw recycling credit. Conversely, a product design having low environmental soundness may receive a recycling credit that is less than the raw recycling credit.

In an embodiment, the raw recycling credit may be adjusted 120 by determining an average generation of the recycled material produced by the manufacturer. The average generation refers to the number of times that the material is produced or recycled during its lifetime. For example, if a material is never recycled, it is considered to be first generation material. If the material is recycled once on average, the average generation of the recycled material is two, and so on. Recycled material having a higher average generation may cause the recycling credit to be increased. Conversely, recycled material having a lower average generation may cause the recycling credit to be decreased.

In an embodiment, the raw recycling credit may be adjusted 120 by determining a source for the recycled material. For example, a manufacturer may have a profile associated with their recycling efforts based on past data, proposals submitted to government agencies or the like. Identifying the source of the recycled material may enable such a profile to be accessed for determining the adjustment.

In an embodiment, the raw recycling credit may be adjusted 120 by determining information pertaining to the bio-origination of the recycled material. Information regarding the material inserted into a product to be recycled may provide data regarding the recyclability of such materials. For example, the type of petroleum product (such as crude oil vs. natural gas) from which a material originated or that was used to produce a product may be used to adjust the recycling credit provided to a manufacturer. Such a determination may be made based on the manufacturer's self-reporting or based on information gathered from tagging and tracking technology.

In an embodiment, the raw recycling credit may be adjusted 120 by determining a value equal to the amount of recycled material that is produced by the manufacturer and recycled divided by the total amount of the recycled material that is produced by the manufacturer. Such an adjustment may encourage the manufacturer to promote recycling of its products containing the recycled material.

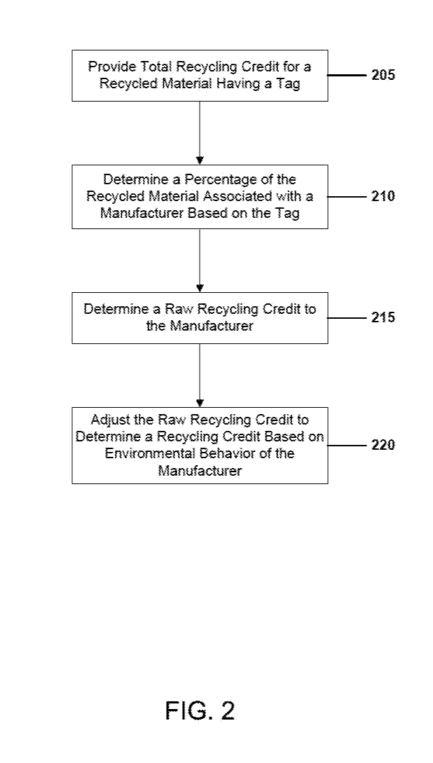

FIG. 2 depicts a flow diagram for an alternate method of determining a recycling credit according to an embodiment. As shown in FIG. 2, a total recycling credit for a recycled material may be provided 205, in which at least a portion of the recycled material includes a tag associated with the manufacturer. In such an embodiment, recycled material (or a portion thereof) that is produced by a producer may be tagged using a tagging technology. The tag may then be read and used to determine information regarding the recycled material. Any tagging technology and/or corresponding tag reader system known by those of ordinary skill in the art may be used within the scope of this disclosure. The tagging technologies useful for the purpose may include, but are not limited to, RFID tagging, magnetic tagging, fluorescence tagging, quantum dot tagging, isotope tagging (such as ¹³C, ¹⁸O, ²H, ¹⁵N, ³³S, ³⁴S or a combination thereof), absorption spectrum tagging (such as infrared (IR) absorption or ultraviolet (UV) absorption), emission spectrum tagging, or a combination thereof. The corresponding tag identification technologies may include, but are not limited to, RFID readers, Raman spectrometers, IR spectrometers, UV spectrometers, nuclear magnetic resonance (NMR) spectrometers, mass spectrometers, elemental analysis, fluorescence spectrometers, or a combination thereof. The recycled material may generally include the types of materials disclosed above in reference to FIG. 1.

A manufacturer percentage corresponding to a percentage of the recycled material associated with the manufacturer based on the portion of the recycled material containing the tag may be determined 210. For example, if half of the recycled material contains a tag associated with a particular manufacturer, the manufacture percentage may be 50% for the recycled material. Alternate determinations may also be made within the scope of this disclosure. For example, a total amount of recycled material containing a tag from a manufacturer, a percentage of the total amount of material produced by a manufacturer that could be recycled or numerous other metrics may be determined.

A processing device may determine 215 a raw recycling credit to provide to the manufacturer by, for example, multiplying the total recycling credit and the manufacturer percentage. The product of the total recycling credit and the manufacturer percentage may be equal to or approximately equal to the amount of the recycled material that is produced by the manufacturer.

The processing device may determine 220 a recycling credit to provide to the manufacturer by adjusting the raw recycling credit. For example, the raw recycling credit may be adjusted with a manufacturer green credit. The manufacturer green credit may be determined based on the manufacturer's environmental behavior.

The manufacturer green credit may be used to adjust 220 the recycling credit provided to the manufacturer positively or negatively depending upon the manufacturer's environmental behavior. Exemplary reasons for adjusting 220 the raw recycling credit may include an average amount of energy consumed when producing the recycled material, a measure of the environmental soundness of the product design of the recycled material, an average generation of the recycled material produced by the manufacturer, a source for the recycled material, information pertaining to the bio-origination of the recycled material, information pertaining to the petroleum origination of the recycled material, and the like. Exemplary adjustments are discussed above in reference to FIG. 1.

In an embodiment, the raw recycling credit may be adjusted 120 by determining a value equal to the amount of recycled material that is produced by the manufacturer and recycled divided by the total amount of the recycled material that is produced by the manufacturer. Such an adjustment may encourage the manufacturer to promote recycling of its products containing the recycled material.

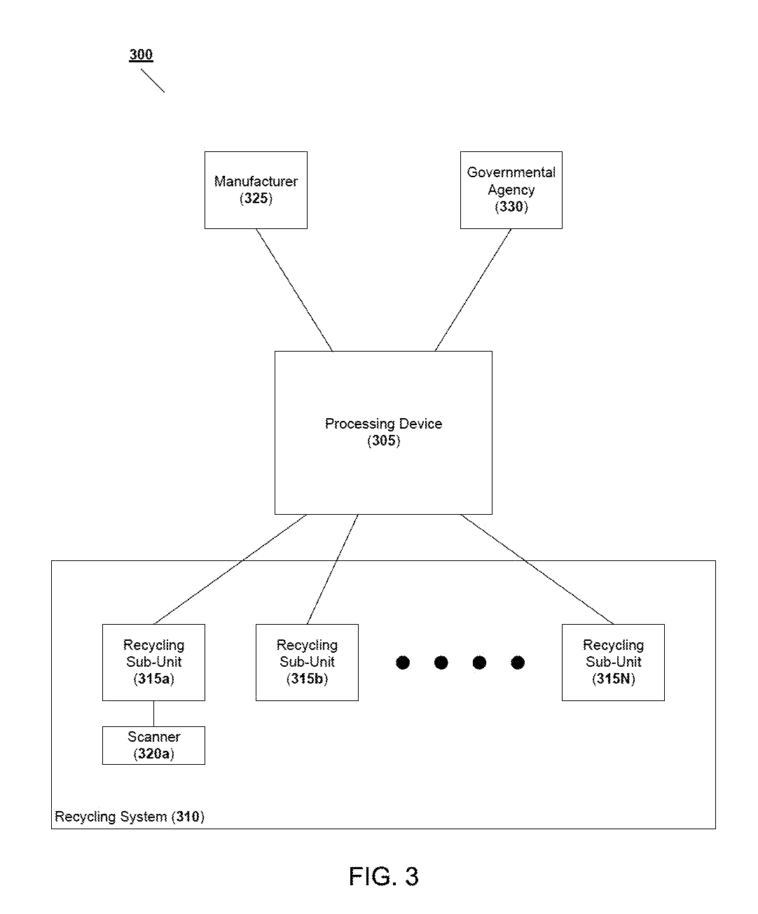

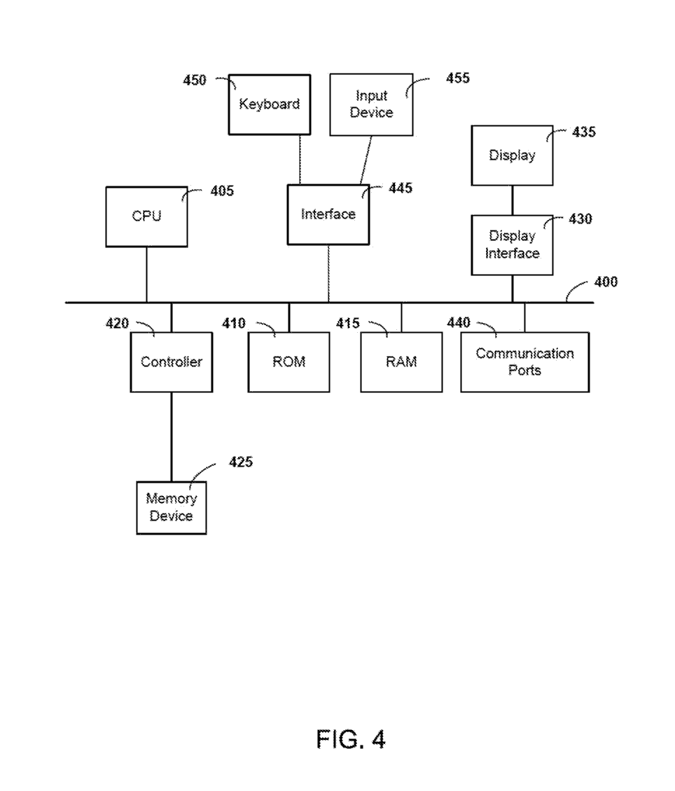

FIG. 3 depicts a block diagram for an illustrative system for determining a recycling credit according to an embodiment. As shown in FIG. 3, the system 300 may include a processing device 305 and a recycling system 310. An exemplary processing device 305 is disclosed in reference to FIG. 4. The recycling system 310 may incorporate sub-units, such as 315a-N dedicated to recycling particular materials. Each recycled material sub-unit, such as 315a may provide information to the processing device regarding the material that is recycled in the sub-unit. For example, a recycled material sub-unit 315a may include a scanner 320a that scans tags associated with the material being recycled in order to obtain information stored on the tags.

This information may be passed to the processing device 305 for further processing such as is described in reference to the figures above. Additionally or alternately, the processing device 305 may be in operable communication with one or more of a manufacturer 325 of material that is recycled, a governmental agency 330, or the like in order to obtain information regarding the material that is being recycled or other pertinent information. The processing device 305 may use the information that it receives to, inter alia, determine a recycling credit to provide to one or more manufacturers.

FIG. 4 depicts a block diagram of exemplary internal hardware that may be used to contain or implement program instructions, such as the process steps discussed above in reference to FIGS. 1 and 2, according to embodiments. A bus 400 serves as the main information highway interconnecting the other illustrated components of the hardware. CPU 405 is the central processing unit of the system, performing calculations and logic operations required to execute a program. CPU 405, alone or in conjunction with one or more of the other elements disclosed in FIG. 4, is an exemplary processing device, computing device or processor as such terms are used within this disclosure. Read only memory (ROM) 410 and random access memory (RAM) 415 constitute exemplary memory devices (i.e., processor-readable non-transitory storage media).

A controller 420 interfaces with one or more optional memory devices 425 to the system bus 400. These memory devices 425 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 410 and/or the RAM 415. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 430 may permit information from the bus 400 to be displayed on the display 435 in audio, visual, graphic or alphanumeric format. Communication with external devices, such as a print device, may occur using various communication ports 440. An exemplary communication port 440 may be attached to a communications network, such as the Internet or an intranet.

The hardware may also include an interface 445 which allows for receipt of data from input devices such as a keyboard 450 or other input device 455 such as a mouse, a joystick, a touch screen, a remote control, a pointing device, a video input device and/or an audio input device.

### Example 1

### Providing a Recycling Credit for Plastics

A manufacturer that makes plastic products identifies that it distributes 1.5 million pounds of plastic products into a particular jurisdiction having a recycling center in a given time period and provides this information to the recycling center. The recycling center identifies that it recycles 10 million pounds of plastics in the same time period and attributes 15% as the manufacturer percentage for that manufacturer. The recycling center further identifies a total recycling credit for plastic of $100,000. The manufacturer is thus assigned a raw recycling credit of $15,000 for the recycled plastics in that jurisdiction. The manufacturer produces its plastics using dated technology that relies on carbon-based fuels and does not use a significant amount of recycled materials when developing its products. As such, an adjustment of $1,000 is made to the raw recycling credit resulting in a $14,000 credit being assigned to the manufacturer.

### Example 2

### Providing a Recycling Credit for a Tagged Material

A recycling center identifies that it recycles 50 million pounds of aluminum in a given period of time. The recycling center includes a scanner that enables identification of tags placed on the aluminum that it recycles. The recycling center identifies that 15% of the aluminum that passes through the recycling center includes a tag identifying that the associated aluminum was produced by a particular manufacturer. As such, the recycling center determines that a manufacturer's percentage for the manufacturer for aluminum is 15%. The recycling center further identifies a total recycling credit for aluminum of $100,000. The manufacturer is thus assigned a raw recycling credit of $15,000 for the recycled aluminum in that jurisdiction. The manufacturer produces its aluminum using clean technologies and uses recycled products to generate the aluminum that it uses in its products. In addition, the manufacturer's products are designed to be easily separable into its discrete components in order to ease recycling of the product by its consumers. As such, an adjustment of $1,250 is made to the raw recycling credit resulting in a $16,250 recycling credit being assigned to the manufacturer.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one ore more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of determining a recycling credit, the method comprising:
providing a total recycling credit for a recycled material;
providing a manufacturer percentage of the recycled material for a manufacturer, wherein the manufacturer percentage comprises a percentage of the recycled material associated with the manufacturer;
determining, by a processing device, a raw recycling credit to the manufacturer by multiplying the total recycling credit and the manufacturer percentage; and
determining, by the processing device, a recycling credit to the manufacturer by adjusting the raw recycling credit with a manufacturer green credit determined based on a manufacturer's environmental behavior.

2. The method of claim 1, wherein the recycled material comprises a thermoplastic polymer, a thermosetting polymer, a biodegradable polymer or a combination thereof.

3.-7. (canceled)

8. The method of claim 1, wherein the manufacturer percentage comprises a percentage of the recycled material that is produced by the manufacturer by weight.

9. The method of claim 1, wherein providing a manufacturer percentage comprises:
determining a chemical composition of the recycled material, wherein the chemical composition comprises a plurality of chemical compounds and corresponding percentages of the recycled material attributable to each chemical compound; and
determining the manufacturer percentage of the recycled material produced by a manufacturer based on the chemical composition of the recycled material.

10. The method of claim 1, wherein providing a manufacturer percentage comprises determining the manufacturer percentage based on a market share of the manufacturer with respect to the recycled material.

11. The method of claim 1, wherein adjusting the raw recycling credit with a manufacturer green credit comprises determining an average amount of energy consumed when producing the recycled material.

12. The method of claim 1, wherein adjusting the raw recycling credit with a manufacturer green credit comprises determining a measure of environmental soundness of a product design of the recycled material.

13.-17. (canceled)

18. A method of determining a recycling credit, the method comprising:
providing a total recycling credit for a recycled material, wherein at least a portion of the recycled material comprises a tag associated with a manufacturer;
determining a manufacturer percentage corresponding to a percentage of the recycled material associated with the manufacturer based on the portion of the recycled material containing the tag;
determining, by a processing device, a raw recycling credit to the manufacturer by multiplying the total recycling credit and the manufacturer percentage; and
determining, by the processing device, a recycling credit to the manufacturer by adjusting the raw recycling credit with a manufacturer green credit determined based on a manufacturer's environmental behavior.

19. (canceled)

20. The method of claim 18, wherein the recycled material comprises polyethylene, polypropylene, polystyrene, polyvinyl chloride, polyacrylates, polyethylene terephthalate, polyacrylonitrile, polytetrafluoroethylene, polyester, polycarbonate, polyimide, polyamide, polyurethane or a combination thereof.

21.-24. (canceled)

25. The method of claim 18, wherein the tag comprises a radio frequency identification (RFID) tag, a magnetic tag, a fluorescence tag, a quantum dot tag, an isotope tag, an absorption spectrum tag, an infrared absorption tag, an ultraviolet absorption tag, an emission spectrum tag or a combination thereof.

26. The method of claim 18, wherein the tag comprises a ¹³C tag, a ¹⁸O tag, a ²H tag, a ¹⁵Ntag, a ³³S tag, a ³⁴S tag or a combination thereof.

27. The method of claim 18, further comprising receiving tag identification information pertaining to the tag on the at least a portion of the recycled material from an identification device.

28. (canceled)

29. The method of claim 18, wherein determining the manufacturer green credit comprises determining an average amount of energy consumed when producing the recycled material.

30. (canceled)

31. The method of claim 18, wherein adjusting the raw recycling credit with a manufacturer green credit comprises one or more of:
determining an average generation of the recycled material produced by the manufacturer; and
determining a source for the recycled material.

32.-35. (canceled)

36. A system for determining a recycling credit, the system comprising:
a processing device; and
a non-transitory computer-readable storage medium in operable communication with the processing device,
wherein the computer-readable storage medium contains one or more programming instructions that, when executed, cause the processing device to:
determine a total recycling credit for a recycled material,
determine a manufacturer percentage of the recycled material for a manufacturer, wherein the manufacturer percentage comprises a percentage of the recycled material associated with the manufacturer,
determine a raw recycling credit to the manufacturer by multiplying the total recycling credit and the manufacturer percentage, and
determine a recycling credit to the manufacturer by adjusting the raw recycling credit with a manufacturer green credit determined based on a manufacturer's environmental behavior.

37.-38. (canceled)

39. The system of claim 36, wherein the recycled material comprises epoxy resin, allyl resin, silicone, polyimide, polyurethane, or a combination thereof.

40.-42. (canceled)

43. The system of claim 36, wherein the one or more programming instructions that, when executed, cause the processor to determine the manufacturer percentage comprise one or more programming instructions that, when executed, cause the processor to:
determine a total weight of the recycled material;
determine a weight of the recycled material produced by the manufacturer;
divide the weight of the recycled material produced by the manufacturer by the total weight to determine the manufacturer percentage.

44. The system of claim 36, wherein the one or more programming instructions that, when executed, cause the processor to determine the manufacturer percentage comprise one or more programming instructions that, when executed, cause the processor to:
determine a chemical composition of the recycled material, wherein the chemical composition comprises a plurality of chemical compounds and corresponding percentages of the recycled material attributable to each chemical compound; and
determining a manufacturer percentage for the recycled material produced by a manufacturer based on the chemical composition of the recycled material.

45. The system of claim 36, wherein the one or more programming instructions that, when executed, cause the processor to determine the manufacturer percentage comprise one or more programming instructions that, when executed, cause the processor to:
determine a market share for the manufacturer with respect to the recycled material; and
assign the manufacturer percentage for the manufacturer to be equal to the market share for the manufacturer.

46. The system of claim 36, wherein the one or more programming instructions that, when executed, cause the processor to determine a recycling credit to the manufacturer by adjusting the raw recycling credit with a manufacturer green credit comprise one or more programming instructions that, when executed, cause the processor to determine an average amount of energy consumed when producing the recycled material.

47.-49. (canceled)

50. The system of claim 36, wherein the one or more programming instructions that, when executed, cause the processor to determine a recycling credit to the manufacturer by adjusting the raw recycling credit with a manufacturer green credit comprise one or more programming instructions that, when executed, cause the processor to perform one or more of:
determining information pertaining to the bio-origination of the recycled material; and
determining information pertaining to the petroleum origination of the recycled material.

51.-52. (canceled)

53. A system for determining a recycling credit, the system comprising:
a processing device;
an identification device in operable communication with the processor; and
a non-transitory computer-readable storage medium in operable communication with the processing device,
wherein the computer-readable storage medium contains one or more programming instructions that, when executed, cause the processing device to:
determine a total recycling credit for a recycled material, wherein at least a portion of the recycled material comprises a tag associated with a manufacturer,
receive tag identification information pertaining to the tag on the at least a portion of the recycled material from the identification device,
determine a manufacturer percentage corresponding to a percentage of the recycled material associated with the manufacturer based on the recycled material and the at least a portion of the recycled material comprising the tag,
determine a raw recycling credit to the manufacturer by multiplying the total recycling credit and the manufacturer percentage, and
determine a recycling credit to the manufacturer by adjusting the raw recycling credit with a manufacturer green credit determined based on a manufacturer's environmental behavior.

54.-58. (canceled)

59. The system of claim 53, wherein the recycled material comprises metal, glass, ceramics or a combination thereof.

60. The system of claim 53, wherein the tag comprises a radio frequency identification (RFID) tag, a magnetic tag, a fluorescence tag, a quantum dot tag, an isotope tag, an absorption spectrum tag, an infrared absorption tag, an ultraviolet absorption tag, an emission spectrum tag or a combination thereof.

61. The system of claim 53, wherein the identification device comprises one or more of the following: a radio frequency identification (RFID) reader, a Raman spectrometer, an infrared (IR) spectrometer, an ultraviolet (UV) spectrometer, a nuclear magnetic resonance (NMR) spectrometer, a mass spectrometer, an elemental analyzer, and a fluorescence spectrometer.

62. The system of claim 53, wherein the one or more programming instructions that, when executed, cause the processor to determine a recycling credit to the manufacturer by adjusting the raw recycling credit with a manufacturer green credit comprise one or more programming instructions that, when executed, cause the processor to determine an average amount of energy consumed when producing the recycled material.

63.-67. (canceled)

68. The system of claim 53, wherein the one or more programming instructions that, when executed, cause the processor to determine a recycling credit to the manufacturer by adjusting the raw recycling credit with a manufacturer green credit comprise one or more programming instructions that, when executed, cause the processor to determine a value equal to the recycled material that is produced by the manufacturer and recycled divided by the total amount of the recycled material that is produced by the manufacturer.
